(19) United States
(12) Patent Application Publication
(10) Pub. No.: US 2007/0296741 A1
(43) Pub. Date: Dec. 27, 2007

(54) MULTI-COLOR DISPLAY DEVICE AND DRIVING METHOD THEREFOR

(76) Inventors: Kyong-Tae Park, Uijeongbu-si (KR); Beohm-Rock Choi, Seoul (KR); II-Nam Kim, Suwon-si (KR); Sung-Soo Lee, Suwon-si (KR); Ji-Hye Choi, Yongin-si (KR)

Correspondence Address: MACPHERSON KWOK CHEN & HEID LLP, 2033 GATEWAY PLACE, SUITE 400, SAN JOSE, CA, 95110, US

(21) Appl. No.: 11/681,632

(22) Filed: Mar. 2, 2007

(30) Foreign Application Priority Data
Jun. 21, 2006 (KR) 10-2006-0055859

(51) Int. Cl. G09G 5/10; G09G 3/32

(52) U.S. Cl. 345/690; 345/83

(57) ABSTRACT

A display device and a driving method using four color pixels, a signal processor that converts three input image signals having gray levels to four output image signals that display four colors based on a look-up table without separate gamma conversion; and a data driver that generates a data voltage based on the output image signal and that supplies the data voltage to the pixels, thereby simplifying signal processing.

### CROSS-REFERENCE TO RELATED APPLICATION

This application claims priority to and the benefit of Korean Patent Application No. 10-2006-0055859 filed in the Korean Intellectual Property Office on Jun. 21, 2006, the contents of which are incorporated herein by reference.

### FIELD OF THE INVENTION

The present invention relates to a multi-color organic light emitting diode (OLED) display that includes a pixel for displaying four or more colors.

### DESCRIPTION OF THE RELATED ART

Flat panel displays generally include a plurality of pixels that are arranged in a matrix shape based on three primary colors. The image that is displayed is determined by combining the three pixel colors and by appropriately controlling the luminance of each. However, when an image is displayed with only three primary colors, light efficiency is affected. This is particularly so in an OLED display since the emission layer material of the OLED changes depending on color. Accordingly, a method of adding a white pixel that emits white color light in addition to pixels of three primary colors has been suggested.

Such a four color display device receives input image signals for pixels of three primary colors, for example of red, green, and blue to generate output image signals for the red, green, blue, and white pixels. In order to perform the work, a complicated gamma conversion process is performed on the gray levels of the input image signal and then the luminance of the output image signal is obtained by performing various operations in a luminance space, followed by degamma conversion. However, this is expensive because large memory capacity is required to perform the gamma and degamma conversions.

### SUMMARY OF THE INVENTION

The present invention converts three color input image signals to four color output image signals with only a small capacity of memory. A signal processor converts the three colors of input image signals having gray levels to four color output image signals based on a look-up table without separate gamma conversion. A data driver generates a data voltage based on the output image signal that supplies the data voltage to the pixel. The output image signal that displays the fourth color may be directly extracted from one of the input image signals without resort to the look-up table, and one of the output image signals that display the three colors may be determined without reference to the look-up table.

The input image signals may include three input image signals that are aligned sequentially from signals having a large gray value and the output image signals may include three output image signals that display the same color as that of the three input image signals, respectively, and a fourth output image signal that displays a fourth color; the fourth output image signal may have the same gray level as that of the third input image signal; and the gray value of the third output image signal may be zero.

The first and second output image signals may either have the same gray level as a reference conversion gray level that is stored in the look-up table or a gray that is obtained by performing only four fundamental rules of arithmetic for the conversion gray, the first to third input image signals, and a constant. The reference conversion gray may be a gray that the first or the second output image signal should have when the first or second input image signal is a reference gray. When the first or the second input image signal is the reference gray, the luminance that the reference conversion gray displays may be equal to the difference between the luminance that the third input image signal displays and the luminance that the reference gray displays.

The signal processor may include a first signal alignment unit that aligns the input image signals depending on their gray levels; a converter that generates first and second conversion image signals from the first, second, and third input image signals; and a second signal alignment unit that determines and outputs the output image signal from the first and second conversion image signals and the third input image signal.

The converter may include a look-up table that stores the first or the second conversion image signal as a function of the first or the second input image signal and the third input image signal.

The converter may include one look-up table that stores a reference conversion image signal as a function of the third input image signal when the first or the second input image signal is a reference gray. The converter may input an value that is obtained by performing four fundamental rules of arithmetic with the first or the second input image signal, the third input image signal, and the reference gray to the look-up table to extract the reference conversion image signal and generate the first or the second conversion image signal by performing four fundamental rules of arithmetic with the reference conversion image signal, the first or the second input image signal, and the reference gray.

The first or the second conversion image signal D′ may satisfy the following equation:

D′(D,D3)=D/D_{ref}*F(D3*D_{ref}/D)_{D1ref}

(where D is a first or a second input image signal, D3 is a third input image signal, and D_{ref} is a reference gray).

The reference gray may be 2^{N}−1 (where N is the bit number of an input image signal). The first or the second conversion image signal D′ may satisfy the following equation:

D′(D,D3)=F{(D3+1)*2^{N}/(D+1)−1}_{D1ref}*(D+1)/2^{N}

(where D is a first or a second input image signal, D3 is a third input image signal, and D_{ref} is a reference gray).

The converter may perform a multiplication and a division of 2^{N} with a shift operation.

When the first or the second input image signal is the reference gray, a luminance that the reference conversion gray displays may be equal to a luminance of a value of a difference between the luminance that the third input image signal displays and the luminance that the reference gray displays.

Another embodiment of the present invention provides a driving method of a display device including: receiving three input image signals that display each of three primary colors; aligning the input image signals to first, second, and third input image signals aligned sequentially from signals having a large gray; extracting a white output image signal from the third input image signal; obtaining a first input gray by performing four fundamental rules of arithmetic with the first and third input image signals and a reference gray; obtaining a first reference conversion image signal by inputting the first input gray to a look-up table; obtaining a first conversion image signal by performing four fundamental rules of arithmetic with the first reference conversion image signal, the first and third input image signals, and the reference gray; obtaining a second input gray by performing four fundamental rules of arithmetic with the second and third input image signals and the reference gray; obtaining a second reference conversion image signal by inputting the second input gray to a look-up table; obtaining a second conversion image signal by performing four fundamental rules of arithmetic with the second reference conversion image signal, the second and third input image signals, and the reference gray; obtaining a third conversion image signal from the third input image signal and the white output image signal; and outputting the first to third conversion image signals and the white output image signal as an output image signal that displays four colors.

The white image signal may have the same gray as the third input image signal and the third conversion image signal may have a gray value of 0.

The luminance that the first reference conversion image signal displays may be equal to the difference between the luminance that the first input gray displays and the luminance that the reference gray displays, and the luminance that the second reference conversion image signal displays may be equal to the difference between the luminance that the second input gray displays and the luminance that the reference gray displays.

### BRIEF DESCRIPTION OF THE DRAWINGS

FIG. 1 is a block diagram of an OLED display according to an exemplary embodiment of the present invention.

FIG. 2 is an equivalent circuit diagram of one pixel of the OLED display according to an exemplary embodiment of the present invention.

FIG. 3 is a top plan view illustrating a plurality of pixels of the OLED display according to an exemplary embodiment of the present invention.

FIG. 4 is a block diagram of a signal processor according to an exemplary embodiment of the present invention.

FIG. 5 is a graph illustrating an output image signal that is generated according to an exemplary embodiment of the present invention as a function of an input image signal.

FIG. 6 is a block diagram of a converter according to an exemplary embodiment of the present invention.

FIG. 7 is a three-dimensional graph illustrating an output image signal that is generated according to an exemplary embodiment of the present invention as a function of an input image signal.

FIG. 8 is a three-dimensional graph illustrating an output image signal that is generated according to another exemplary embodiment of the present invention as a function of an input image signal.

FIG. 9 is a three-dimensional graph illustrating a difference between the graph shown in FIG. 7 and the graph shown in FIG. 8.

### DETAILED DESCRIPTION OF THE EMBODIMENTS

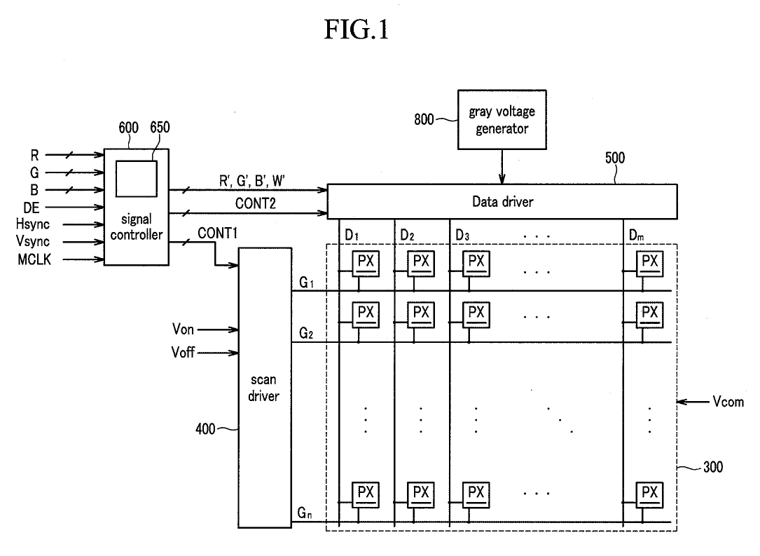

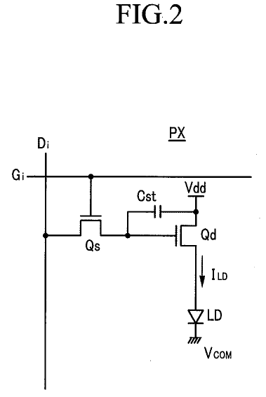

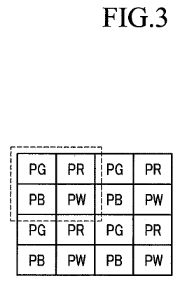

FIG. 1 is a block diagram of the OLED display according to an exemplary embodiment of the present invention, FIG. 2 is an equivalent circuit diagram of one pixel of the OLED display according to an exemplary embodiment of the present invention, and FIG. 3 is a view illustrating a pixel arrangement of the OLED display according to an exemplary embodiment of the present invention.

Referring to FIG. 1, the OLED display according to an embodiment of the present invention includes a display panel 300, a scan driver 400 and a data driver 500 that are connected to the display panel 300, a gray voltage generator 800 that is connected to the data driver 500, and a signal controller 600 that controls them.

The display panel 300 includes a plurality of signal lines G₁-Gₙ and D₁-Dₘ, a plurality of voltage lines (not shown), and a plurality of pixels PX that are connected to them and arranged in approximately a matrix shape from an equivalent circuital view.

Scanning signal lines G₁-Gₙ and D₁-Dₘ include a plurality of gate lines G₁-Gₙ that transfers a scanning signal and data lines D₁-Dₘ that transfer a data signal. Scanning lines G₁-Gₙ are extended in approximately a row direction and are separated from and almost parallel to each other. Data lines D₁-Dₘ are extended in approximately a column direction and are almost parallel to each other. Each voltage line (not shown) transfers a driving voltage Vdd, etc.

Referring to FIG. 2, one pixel PX of the OLED display, for example a pixel PX that is connected to an i-th scanning line Gᵢ (i=1, 2, . . . , n) and a j-th data line Dⱼ(j=1, 2, . . . , m), includes an OLED LD, a driving transistor Qd, a capacitor Cst, and a switching transistor Qs.

Switching element Q is a three terminal element having a control terminal, an input terminal, and an output terminal. The control terminal is connected to the scanning line Gᵢ, the input terminal is connected to the data line Dⱼ, and the output terminal is connected to a control terminal of the driving transistor Qd. The switching transistor Qs transfers a data voltage in response to a scanning signal that is applied through the scanning line Gᵢ.

Driving transistor Qd is a three terminal element also includes a control terminal, an input terminal, and an output terminal. The control terminal is connected to the switching transistor Qs, the input terminal is connected to the driving voltage Vdd, and the output terminal is connected to the OLED LD. The driving transistor Qd provides an output current ILD whose magnitude depends on the voltage that is applied between its control and output terminals.

Capacitor Cst is connected between the control terminal and the input terminal of the driving transistor Qd. The capacitor Cst charges to the data voltage that is applied to the control terminal of the driving transistor Qd through the switching transistor Qs and maintains the voltage even after the switching transistor Qs is turned off.

The OLED LD has an anode that is connected to the output terminal of driving transistor Qd and a cathode that is connected to the common voltage Vcom. The OLED LD emits light by changing its intensity depending on an output current ILD, thereby displaying an image. The OLED LD emits a light color depending on its material.

Referring to FIG. 3, the pixels, that is, a red pixel PR, a green pixel PG, a blue pixel PB, and a white pixel PW are arranged in 2×2 matrix called a “dot”. The OLED display has a structure in which the dots are repeatedly disposed in a row direction and a column direction. For the best color characteristics within each dot, the red pixel PR and the blue pixel PB are opposed to each other in a diagonal direction and the green pixel PG and the white pixel PW are opposed to each other in a diagonal direction. However, such four color pixels PR, PG, PB, and PW may have a stripe structure and a pentile structure in addition to the checked structure of FIG. 3.

Switching transistor Qs and driving transistor Qd are n-channel metal oxide semiconductor field effect transistors (FETs) that are made of amorphous silicon or polysilicon. However, at least one of the transistors Qs and Qd may be a p-channel MOSFET. Furthermore, the connection relationship of the transistors Qs and Qd, the capacitor Cst, and the OLED LD may be changed.

Referring again to FIG. 1, scan driver 400 applies a scanning signal to scanning lines G₁-Gₙ consisting of a high voltage Von to turn on switching transistor Qs and a low voltage Voff to turn off the switching transistor. Data driver 500 applies an image data voltage to data lines D₁-Dₘ. Gray voltage generator 800 generates and applies to data driver 500 a number of gray voltage sets. The gray voltage set can be different for each color considering light emitting efficiency and the life expectancy of the light emitting material. Signal controller 600 controls the scan driver 400, the data driver 500, and the gray voltage generator 800, etc., and includes a signal processor 650 that generates four color output image signals R′, G′, B′, and W′ from three color input image signals R, G, and B. Signal processor 650 will be described in detail later.

Each of the driving devices 400, 500, 600, and 800 may be directly mounted on the display panel 300 in a form of at least one IC chip, mounted on a flexible printed circuit film (not shown) to attach to the display panel 300 in a form of a tape carrier package (TCP), or mounted on a separate printed circuit board (PCB) (not shown). Alternatively, the driving devices 400, 500, 600, and 800 along with the signal lines G₁-Gₙ and D₁-Dₘ, and the transistors Qs and Qd, etc. may be integrated in the display panel 300. Furthermore, the driving devices 400, 500, 600, and 800 may be integrated in a single chip, and in this case at least one among them or at least one circuit element constituting them may be provided outside of the single chip.

Signal controller 600 receives three color input image signals R, G, and B and an input control signal from an external graphics controller (not shown). The three input image signals R, G, and B are digital signals that have a gray level corresponding to the luminance of each pixel PX based on three colors and the number of the gray levels, for example 1024 (=2¹⁰), 256 (=2⁸), or 64 (=2⁶). The luminance of each gray is given by the gamma curve for the particular display device. Converting the input image signals R, G, and B and gray level to luminance is called “gamma conversion.”

The input control signal includes, for example, a vertical synchronization signal Vsync, a horizontal synchronization signal Hsync, a main clock signal MCLK, and a data enable signal DE.

Signal processor 650 extracts a white image signal from the three color input image signals R, G, and B, corrects the input image signals R, G, and B, then appropriately processes the signals depending an operating requirements of the display panel 300, thereby generating red, green, blue, and white output image signals R′, G′, B′, and W′.

Signal controller 600 also generates a scan control signal CONT1, a data control signal CONT2, and a gray control signal CONT3, etc., then sends the scan control signal CONT1 to scan driver 400, the data control signal CONT2 and the processed output image signals R′, G′, B′, and W′ to data driver 500, and the gray control signal CONT3 to gray voltage generator 800.

Scan control signal CONT1 includes a scanning start signal STV and at least one clock signal that controls the output period of the high voltage Von. Gate control signal CONT1 may further include an output enable signal OE that limits the sustain time of the high voltage Von.

Data control signal CONT2 includes a horizontal synchronization start signal STH that starts the transfer of digital output image signals R′, G′, B′, and W′ for one row of pixels PX, and a data clock signal HCLK and a load signal LOAD that apply an analog data voltage to the data lines D₁-Dₘ.

Data driver 500 receives four color output image signals R′, G′, B′, and W′ depending on data control signal CONT2 and converts the signals to an analog voltage.

Scan driver 400 converts the scanning signal to the high voltage Von depending on the scan control signal CONT1 from signal controller 600.

Then, switching transistors Qs of a corresponding pixel row are turned on and driving transistor Qd receives a corresponding data voltage through the turned-on switching transistor Qs. Each driving transistor Qd outputs a driving current I_{LD} corresponding to the applied data voltage to the OLED LD. Accordingly, the OLED LD emits light of a magnitude corresponding to the driving current I_{LD}.

At this time, a data voltage Vdat and a driving current I_{LD} depending on the voltage are determined by considering light emitting efficiency and the life expectancy of each OLED LD that may be different for each color. Furthermore, luminance can be increased by providing a white pixel W.

Such an operation is sequentially performed up to the nth row of pixels PX to display one image.

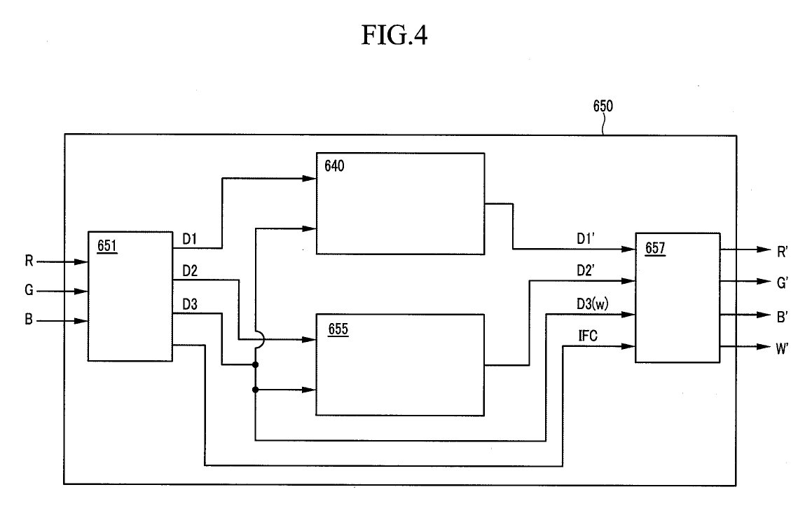

Now, referring to FIGS. 4 to 9, the signal processor 650 will be described in detail.

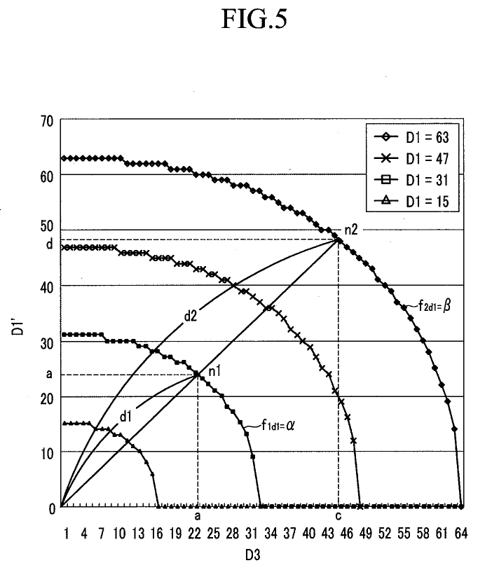

FIG. 4 is a block diagram of a signal processor according to an exemplary embodiment of the present invention, and FIG. 5 is a graph illustrating an output image signal that is generated according to an exemplary embodiment of the present invention as a function of an input image signal.

Referring to FIG. 4, signal processor 650 receives a set of three color input image signals R, G, and B from the outside to generate one white image signal W′ and three color output image signals R′, G′, and B′. Processor 650 includes a first signal alignment unit 651, a first converter 640, a second converter 655, and a second signal alignment unit 657.

The first signal alignment unit 651 receives the set of three color input image signals R, G, and B from the outside and aligns the input image signals depending on their gray levels. The input image signals R, G, and B may be sequentially aligned from signals having a high gray value.

When the signals are aligned in this method, they are called a first signal D1, a second signal D2, and a third signal D3 aligned sequentially from the input image signals having a high gray value. The grays of the first, second, and third signals D1, D2, and D3 are sequentially called a first gray, a second gray, and a third gray.

The first signal alignment unit 651 outputs the first signal D1 and the third signal D3 to the first converter 640, outputs the second signal D2 and the third signal D3 to the second converter 655, and outputs the third signal D3 and color information IFc for the respective signals D1, D2, and D3 to the second signal alignment unit 657.

The first converter 640 converts the first signal D1 to a first conversion signal D1′ based on the third signal D3, and the second converter 655 converts a second signal D2 to the second conversion signal D2′ depending on the third signal D3. The first and second converters 640 and 655 will be described in detail later.

The second signal alignment unit 657 determines four color output image signals R′, G′, B′, and W′ depending on the first and second conversion signals D1′ and D2′ that are received from the first and second converters 640 and 655, and the third signal D3 and color information IFc that are received from the first signal alignment unit 651, and then outputs them. At this time, the white output image signal W′ has the same gray as the third signal D3, the first and second output image signals for colors that the first and second signals D1 and D2 display are equal to the first and second conversion signals D1′ and D2′, respectively, and the third output image signal for a color that the third signal D3 displays may be set to display a gray value of 0.

Hereinafter, signal conversion by the first and second converters 640 and 655 will be described. Because a digital image signal can display with a number of the binary scale and this number is just a gray that is displayed with the binary scale, various image signals and the grays thereof will be treated as the same and are designated by like reference numerals.

The first conversion signal or the gray thereof (hereinafter, referred to as a “first conversion gray”) D1′ that is generated from the first converter 640 may be represented with the following equation.

D1′=F(D1,D3) (Equation 1):

The first conversion gray D1′ can be determined depending on a predetermined rule. For example, the luminance that the first conversion gray D1′ displays can be set to be equal to the luminance value of the difference between the luminance that the third gray D3 displays and the luminance that the first gray D1 displays.

FIG. 5 is an example of the function F of Equation 1, showing a curved line that displays the first conversion gray D1′ as a function of the third gray D3 with respect to various values (=15, 31, 47, 63) of the first gray D1 in a 64-gray display device.

The curved lines of FIG. 5 are a decreasing function, and the first conversion gray D1′ has the same value as that of the first gray D1 when the third gray D3 has a value of 0 and the first conversion gray D1′ has a value of 0 when the third gray D3 has the same value as that of the first gray D1. Furthermore, the first conversion gray D1′ increases as the first gray D1 increases.

The first converter 640 may include a look-up table (not shown) that stores a value of the first conversion gray D1′ corresponding to a pair of the first gray D1 and the third gray D3. At this time, if the first conversion grays D1′ for all pairs of the first gray D1 and the third gray D3 are stored, the memory capacity of a look-up table should be very large.

However, it can be seen that the curved lines shown in FIG. 5 have “linearity”. Here, linearity means that the ratio between the distance d1 from a starting point to an intersection point n1 and the distance d2 from the starting point to an intersection point n2 is constant. Therefore, the curved lines f1 and f2 have “linearity” when the first gray is α and β, respectively, and when the coordinates of intersection point n1 is (a, b), the coordinates of intersection point n2 is (c, d), the coordinates satisfy the following equation:

d1:d2=α:β:=a:c=b:d

The size of a look-up table for the first converter 640 can be reduced by applying the linearity function. For example, the look-up table of the first converter 640 stores a first conversion gray (=F_{D1ref}) when the first gray D1 is a reference gray (=D1_{ref}) as a function of the third gray D3.

Referring to FIG. 5 and Equation 2, the first converter 640 seeks input grays (c=αβ/α=D3*D1_{ref}/D1) to input to a look-up table by performing “linear conversion” of the third gray (D3=a) based on the first gray (D1=α) and the reference gray D1_{ref}=β. Here, linear conversion is conversion that is performed with four fundamental rules of arithmetic, and for example means an operation that is obtained from a proportional expression of Equation 2.

The first converter 640 finds a reference conversion gray [d=F(c)_{D1ref}=F(D3*D1_{ref}/D1)_{D1ref}] by inputting an input gray to a look-up table, and obtains a corresponding first conversion gray (D1′=b=ad/c) by performing linear conversion of the gray based on the first gray D1 and the reference gray D1_{ref}. At this time, a luminance that the reference conversion grays displays may be equal to a luminance of a value of a difference between the luminance that the input gray displays and the luminance that the reference grays D1 ref displays.

Therefore, the first conversion gray D1′ may be represented with the following equation.

D1′(D1,D3)=(D1/D1_{ref})*F(D3*D1_{ref}/D1)_{D1ref} (Equation 3):

The reference gray D1_{ref} may be a maximum value that the input image signals R, G, and B may have, for example, 2^{N}−1 as the number of the decimal scale when the bit number of the input image signals R, G, and B is N (where N is a natural number). At this time, the minimum value that the input image signals R, G, and B may have is 0. If N is 8, the maximum gray that the input image signals R, G, and B may have is 255 and the minimum gray thereof is 0.

At this time, the operation of Equation 3 includes only four fundamental rules of arithmetic.

In order to simplify operation, ‘1’ is added to a gray of each image signal, for example, the maximum gray that the input image signals R, G, and B may have may be 2N and the minimum gray thereof may be 2⁰. Then, Equation 3 may be represented as in the following equation.

D1′(D1,D3)=F{(D3+1)*2^{N}/(D1+1)−1}_{D1ref}*(D1+1)/2^{N}

In this way, a multiplication and a division of Equation 4 can be simply performed with an N cipher shift operation.

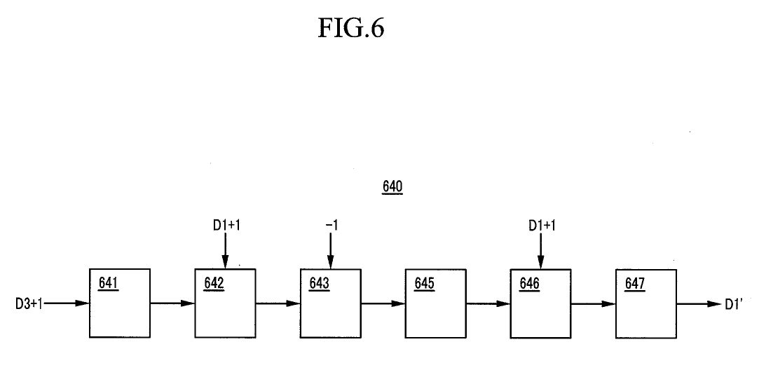

Now, the specific process of Equation 4 will be described in detail with reference to FIG. 6 illustrating the converters of the signal processor shown in FIG. 4.

Referring to FIG. 6, Equation 4 is performed through a first shift unit 641 of the first converter 640, a divider 642, an adder 643, a look-up table 645, a multiplier 646, and a second shift unit 647.

The first converter 640 adds ‘1’ to the third gray D3 to input this to the first shift unit 641.

The first shift unit 641 shifts an input value (D3+1) up by an N cipher and this shift operation is to put the N number ‘0’ behind the input value (D3+1) that is the binary number and is the same as an operation that multiplies 2N. For example, when the third signal D3 is an 8-bit signal, an output value of the first shift unit 641 becomes a 16-bit digital value.

The divider 642 divides the output of the first shift unit 641 by a value (D1+1) that adds ‘1’ to the first gray D1 and represents this with an N bit.

The adder 643 adds ‘−1’ to the output of the divider 642.

The first converter 640 extracts a first conversion gray D1′ of a corresponding address that is stored in the look-up table 645 using the output of the adder 643 as an address and inputs this to the multiplier 646.

As the multiplier 646 multiplies a value that adds ‘1’ to the first gray D1 by the first conversion gray D1′, the output of the multiplier 646 again becomes a 2N bit.

The second shift unit 647 shifts the output of the multiplier 646 down by an N bit. The shift operation of the second shift unit 467 can be simply performed by removing a value of the lower N bit among the outputs of the multiplier 646, and this is the same as an operation that divides by 2^{N}.

The program can be simplified and the memory of the look-up table 645 can be reduced by performing a multiplication and a division with a shift operation.

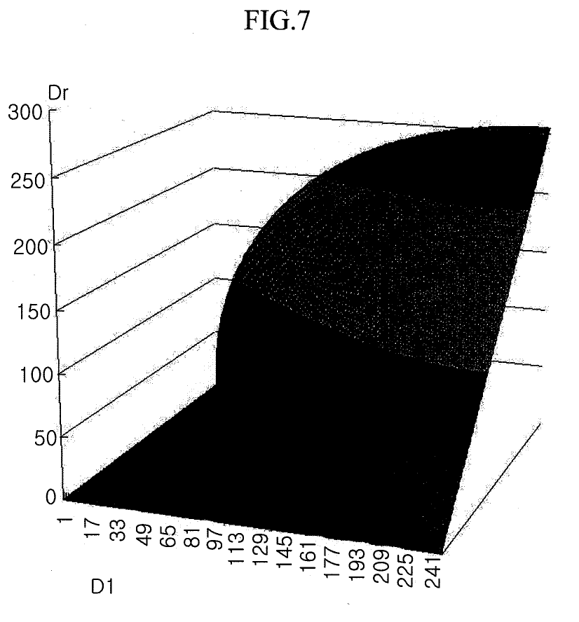

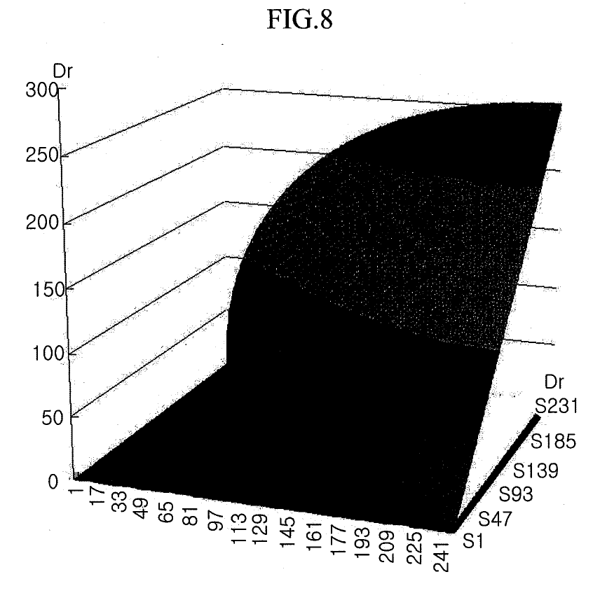

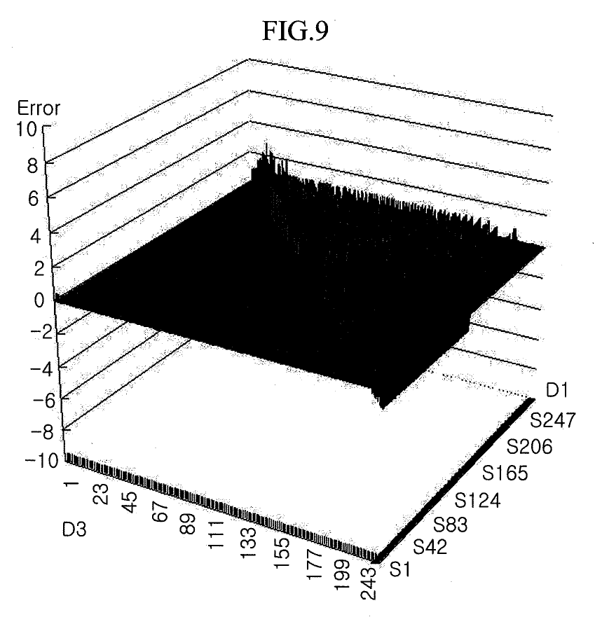

FIG. 7 is a three-dimensional graph illustrating Equation 1 in a 256 level gray system, FIG. 8 is a three-dimensional graph illustrating a function of Equation 4 in the 256 gray system, and FIG. 9 is a three-dimensional graph illustrating a difference between the graph shown in FIG. 7 and the graph shown in FIG. 8.

Referring to FIG. 9, there is no large difference between the graph of FIG. 7 and the graph of FIG. 8, and the average of the difference between the two graphs is merely 0.23%. This difference is relatively large when the first conversion gray D1′ is a low gray. Therefore, since a large difference of about 3 to 4% is generated in a low gray that is displayed as almost black, it may be regarded as image distortion due to a difference that is not visually recognized. Furthermore, if the input image signals R, G, and B are processed with a high digital signal bit, this difference can be reduced.

The second conversion gray D2′ can be obtained with the same method as described above. That is, in the above equations, the second conversion gray D2′ can be generated by operating an equation in which the second gray D2 is used instead of the first gray D1. At this time, a function that is stored in a look-up table of the second converter 655 can be equal to that of the first converter 640. The respective conversion grays D1′ and D2′ may be operated with only a single converter instead of providing each of the first converter 640 and the second converter 655.

According to the present invention, four color image signals are generated from three color input image signals using a simple look-up table without performing gamma-degamma conversion, thereby simplifying signal processing. Furthermore, since only a limited number of conversion values are stored in a look-up table while other values are found through a simple operation, the size of the look-up table can be reduced.

While this invention has been described in connection with what is presently considered to be practical exemplary embodiments, it is to be understood that various modifications and equivalent arrangements will be apparent to those skilled in the art and may be made without, however, departing from the spirit and scope of the invention.

What is claimed is:

1. A display device comprising:
a plurality of pixels that display a first color, a second color, a third color, and a fourth color;
a signal processor that converts three color input image signals having gray levels to four color output image signals based on a look-up table without separate gamma conversion; and
a data driver that generates a data voltage based on the output image signal and that supplies the data voltage to the pixels.

2. The display device of claim 1, wherein the output image signal that displays the fourth color is directly extracted from one of the input image signals without reference to the look-up table.

3. The display device of claim 2, wherein one of output image signals that displays the first color to the third color is determined without resort to the look-up table.

4. The display device of claim 3, wherein the input image signals comprise
first, second, and third input image signals sequentially from signals having a large gray level;
the output image signals comprise first, second, and third output image signals that display the same color as that of the first, second, and third input image signals, respectively, and a fourth output image signal that displays a fourth color having the same gray as that of the third input image signal, the gray value of the third output image signal being zero.

5. The display device of claim 4, wherein the first and second output image signals have the same gray as a reference conversion gray.

6. The display device of claim 4, wherein the first and second output image signals have a conversion gray that is obtained by performing only fundamental arithmetic operations on the reference conversion gray that is stored in the look up table, the first to third input image signals and a constant.

7. The display device of claim 5, wherein the reference conversion gray is a gray that the first or the second output image signal should have when the first or second input image signal is a reference gray.

8. The display device of claim 6, wherein when the first or the second input image signal is the reference gray, the luminance that the reference conversion gray displays is equal to the difference between the luminance that the third input image signal displays and the luminance that the reference gray displays.

9. The display device of claim 1, wherein the signal processor comprises
a first signal alignment unit that aligns the input image signals to first, second, and third input image signals depending on the gray level thereof;
a converter that generates the first and second conversion image signals from the first, second, and third input image signals; and
a second signal alignment unit that determines and outputs the output image signal from the first and second conversion image signals and the third input image signal.

10. The display device of claim 9, wherein the converter comprises a look-up table that stores the first or the second conversion image signal as a function of the first or the second input image signal and the third input image signal.

11. The display device of claim 9, wherein the converter comprises
a look-up table that stores a reference conversion image signal as a function of the third input image signal when the first or the second input image signal is a reference gray; and
the converter inputs an value that is obtained by performing arithmetic operations with the first or the second input image signal, the third input image signal, and the reference gray to extract the reference conversion image signal.

12. The display device of claim 9, wherein the converter generates the first or the second conversion image signal by performing arithmetic with the reference conversion image signal, the first or the second input image signal, and the reference gray.

13. The display device of claim 9, wherein the first or the second
conversion image signal D′ satisfies the following equation:
D′(D,D3)=D/D_{ref}*F(D3*D_{ref}/D)_{D1ref}
(where D is a first or a second input image signal, D3 is a third input image signal, and D_{ref} is a reference gray).

14. The display device of claim 9, wherein the reference gray is 2^{N}−1 (where N is the bit number of an input image signal).

15. The display device of claim 9, wherein the first or the second
conversion image signal D′ satisfies the following equation:
D40 (D,D3)=F{(D3+1)*2^{N}/(D+1)−1}_{D1ref}*(D+1)/2^{N}
(where D is a first or a second input image signal, D3 is a third input image signal, and D_{ref} is a reference gray).

16. The display device of claim 15, wherein the converter performs a multiplication and a division of 2^{N} with a shift operation.

17. The display device of claim 9, wherein when the first or the second input image signal is the reference gray, the luminance that the reference conversion gray displays is equal to the difference between the luminance that the third input image signal displays and the luminance that the reference gray displays.

18. The display device of any one of claims 1 to 17, wherein the first to third colors are three primary colors and the fourth color is white.

19. The display device of claim 9, wherein the pixel comprises an OLED.

20. A driving method of a display device, comprising:
receiving three input image signals that display each of three primary colors;
aligning the input image signals to first, second, and third input image signals from signals having a large gray level;
extracting a white output image signal from the third input image signal;
obtaining a first input gray by performing arithmetic upon the first and third input image signals and a reference gray;
obtaining a first reference conversion image signal by inputting the first input gray to a look-up table;
obtaining a first conversion image signal by performing arithmetic with the first reference conversion image signal, the first and third input image signals, and the reference gray;
obtaining a second input gray by performing arithmetic with the second and third input image signals and the reference gray;
obtaining a second reference conversion image signal by inputting the second input gray to a look-up table;
obtaining a second conversion image signal by performing arithmetic with the second reference conversion image signal, the second and third input image signals, and the reference gray;
obtaining a third conversion image signal from the third input image signal and the white output image signal; and
outputting the first to third conversion image signals and the white output image signal as an output image signal that displays four colors.

21. The driving method of claim 20, wherein the white image signal has the same gray as the third input image signal and the third conversion image signal has a gray value of 0.

22. The driving method of claim 20, wherein a luminance that the first reference conversion image signal displays is equal to a difference between the luminance that the first input gray displays and the luminance that the reference gray displays, and a luminance that the second reference conversion image signal displays is equal to a difference between the luminance that the second input gray displays and the luminance that the reference gray displays.
